(19) United States
(12) Patent Application Publication
(10) Pub. No.: US 2004/0202784 A1
(43) Pub. Date: Oct. 14, 2004

(54) Resist film forming method and a photomask manufacturing method

(75) Inventor: Shuho Motomura, Kumamoto (JP)

Correspondence Address: SUGHRUE MION, PLLC, 2100 PENNSYLVANIA AVENUE, N.W., SUITE 800, WASHINGTON, DC, 20037, US

(73) Assignee: HOYA CORPORATION

(21) Appl. No.: 10/820,791

(22) Filed: Apr. 9, 2004

(30) Foreign Application Priority Data
Apr. 10, 2003 (JP) P2003-106479

(51) Int. Cl. B05D 3/12

(52) U.S. Cl. 427/240; 427/372.2

(57) ABSTRACT

A resist film forming method including a resist coating step, comprising steps of rising by a capillary phenomenon a coating liquid stored below the coating surface of a substrate held facing-downward, bringing the rised coating liquid into contact with the coating surface via a nozzle, and scanning the nozzle along the coating surface of the substrate thereby coating the resist film on the coating surface of the substrate, wherein said method further including a step of drying the coated resist film by moving the substrate at a predetermined speed with the coating surface of the substrate facing downward.

The present invention claims foreign priority to Japanese patent application no. 2003-106479, filed on Apr. 10, 2003 the contents of which is incorporated herein by reference.

### BACKGROUND OF THE INVENTION

1. Field of the Invention

The present invention relates to a resist film forming method to be implemented in the process of producing a photomask and a photomask producing method having processing steps using the resist film forming method.

2. Description of the Related Art

As coaters for applying coating liquids such as photoresists to substrates such as silicon wafers, use has been mainly made of a so-called spin coater for forming a coating film on the surface of a substrate by forming drops of coating liquid in the center of the substrate and turning the substrate at high speed whereby to spread the coating liquid by the action of centrifugal force.

However, the problem in the case of such a spin coater is that there is produced a bulge called a resist fringe in the peripheral edge portion of the substrate. Particularly in the case of a photomask for a liquid crystal display or for use in producing a liquid crystal display, it is needed to apply the resist onto a large substrate (e.g., one side is 300 mm or greater). As the tendency in recent years is for patterns to be made more accurate and for substrates to be made larger in size, development of the technology of forming uniform resist film on large-sized substrates has been desired.

Due to the circumstances above, a coater like a so-called CAP coater has been provided as disclosed in Japanese Patent Unexamined Publication No. JP-A-2001-62370.

The CAP coater is so arranged as to form a coating film by the steps of sinking a nozzle having a capillary gap in a liquid tank stored with a coating liquid, lifting the nozzle to the vicinity of the coating surface of a substrate with the coating surface held facing-downward by vacuum chucking table simultaneously with bringing the coating liquid into contact with the coating surface from the capillary gap and scanning the nozzle along the coating surface.

By the use of this coater, a resist film having uniform thickness is applicable without producing any fringe in the peripheral edge portion of the substrate.

As the CAP coater is equipped with a rotary mechanism for turning the vacuum chucking table vertically, the vacuum chucking table is turned until the chucking surface is facing upward and the substrate is loaded with the coating surface facing up on the chucking surface.

Then the vacuum chucking table is turned until the chucking surface is facing downward again when setting the substrate is completed for resist coating and is turned again until the substrate is held facing-upward when the resist coating is finished.

Even when the CAP coater is employed, however, it will be needed to seek after still more uniformity in film thickness in order to response a desire for highly accurate patterns. In this sense, preventing unevenness in drying after resist coating is an important element to improve uniformity in film thickness.

Although the rotary mechanism in the CAP coater is used to reverse the substrate after the resist coating, the vacuum chucking table may tremble during the resist coating due to backlash in the rotary mechanism and thin film quality has been badly affected thereby.

In order to avoid the situation above, if the vacuum chucking table is loaded with the chucking surface facing downward then the vacuum chucking plate is always kept in horizontal plane and the substrate is prevented from undergoing the backlash, and this is led to improving the yield. Therefore, it has been anticipated to realize the technology mentioned above.

Nevertheless, the following problem has been unsolved to realize such an art.

More specifically, in a clean room where a downflow is formed, a downflow current D is obstructed by the surface of vacuum chucking table 71 as schematically shown in FIG. 8 and the current D thus obstructed runs around the side of a chucking surface 71a and forms an air eddy. When the vacuum chucking table 71 is fixed with the chucking surface facing downward, the coating surface 72a of a substrate 72 is always kept facing-downward, whereby the coating film is exposed to the air eddy. Therefore, unevenness in drying is produced by the air eddy when the coating film is dried by relying on the downflow after the resist coating and unevenness in the thickness of the resist film is produced because the unevenness in drying.

### SUMMARY OF THE INVENTION

An object of the invention made in view of the foregoing problems is to provide a resist film forming method offering excellent uniformity in the thickness of a resist film by drying a coating film so that unevenness in the film thickness is not produced without using a rotary mechanism for reversing a substrate and to provide a photomask producing method using the resist film forming method.

According to a first aspect of the present invention, there is provided a resist film forming method including a resist coating step, having steps of rising by a capillary phenomenon a coating liquid stored below the coating surface of a substrate held facing-downward, bringing the rised coating liquid into contact with the coating surface via a nozzle, and scanning the nozzle along the coating surface of the substrate thereby coating the resist film on the coating surface of the substrate, wherein said method further including a step of drying the coated resist film by moving the substrate at a predetermined speed with the coating surface of the substrate facing downward.

According to a second aspect of the present invention as set forth in the first aspect of the present invention, the resist film is coated by moving the substrate so as to scan the nozzle along the coating surface of the substrate and the coated resist film is dried by moving the substrate to the opposite direction by turning back the way the substrate has been moved for resist coating.

According to a third aspect of the present invention as set forth in the second aspect of the present invention, the predetermined speed is 1.5 m/min or lower.

According to a fourth aspect of the present invention, there is provided a photomask manufacturing method, the improvement wherein the resist coating step having a step of rising by a capillary phenomenon a coating liquid stored below the coating surface of a substrate held facing-downward, bringing the rised coating liquid into contact with the coating surface via a nozzle, and scanning the nozzle along the coating surface of the substrate thereby coating the resist film on the coating surface of the substrate, wherein said method further including a step of drying the coated resist film by moving the substrate at a predetermined speed with the coating surface of the substrate facing downward.

According to a fifth aspect of the present invention as set forth in the fourth aspect of the present invention, the resist film is coated by moving the substrate so as to scan the nozzle along the coating surface of the substrate and the coated resist film is dried by moving the substrate to the opposite direction by turning back the way the substrate has been moved for resist coating for drying the coated resist film.

According to a sixth aspect of the present invention as set forth in the fifth aspect of the present invention, the predetermined speed is 1.5 m/min or lower.

According to a seventh aspect of the present invention as set forth in the third aspect of the present invention, the predetermined speed is ranging from 0.01 to 0.08 m/min.

### BRIEF DESCRIPTION OF THE DRAWINGS

FIG. 1 is a side view of a coater for use according to an embodiment of the invention;

FIG. 2 is a schematic depiction for illustrating a resist circulation mode in the coater used according to the embodiment of the invention;

FIG. 3 is a schematic sectional view of the liquid tank of the coater used according to the embodiment of the invention.

FIG. 4 is a side view of the coater used according to the embodiment of the invention;

FIG. 5 is a schematic sectional view of the liquid tank of the coater used according to the embodiment of the invention.

FIG. 6 is a schematic depiction for illustrating an example using an air current generator;

FIG. 7 is a schematic depiction for illustrating an example using a shield plate; and

FIG. 8 is a schematic depiction for illustrating an air current flow on the periphery of a substrate and an chucking plate according to the prior art.

### DETAILED DESCRIPTION OF THE PREFERRED EMBODIMENT

The invention will now be described in more detail.

A method of drying a resist film according to the invention is characterized in that the resist film is dried by moving a substrate with its coating surface facing downward at a predetermined speed. More specifically, the resist film is dried without using a conventionally-used rotary mechanism in such a condition that coating the substrate has been completed, that is, with the coating surface facing downward. Since the resist film is dried while the substrate is moved at the predetermined speed then, unevenness in drying can be prevented because places exposed to an air current of a running-around downflow in a clean room are uniformized within the substrate plane.

According to the invention, it is preferred that the resist coating is conducted by moving the substrate so as to scan a nozzle along the coating surface and that moving the substrate in the opposite direction for drying is carried out by turning back the way the substrate has been moved for resist coating, whereby the substrate can be mounted to and removed from a table at the same position. In this case, the substrate conveying speed for the resist coating and that for drying the resist may be determined properly. Incidentally, the moving speed at the time of drying is desirably 1.5 m/min or lower; if the speed is greater than 1.5 m/min, the resist film may not sufficiently be dried at a point of time the movement of the substrate is terminated. From the same standpoint above, the moving speed is more desirably 1 m/min or lower and most desirably 0.08 m/min. In case that the substrate conveying speed at the time of drying is too low, productivity is lowered, so that the speed is desirably 0.01 m/min or higher.

The invention will now be described in more detail with reference to the embodiment thereof.

(Embodiment)

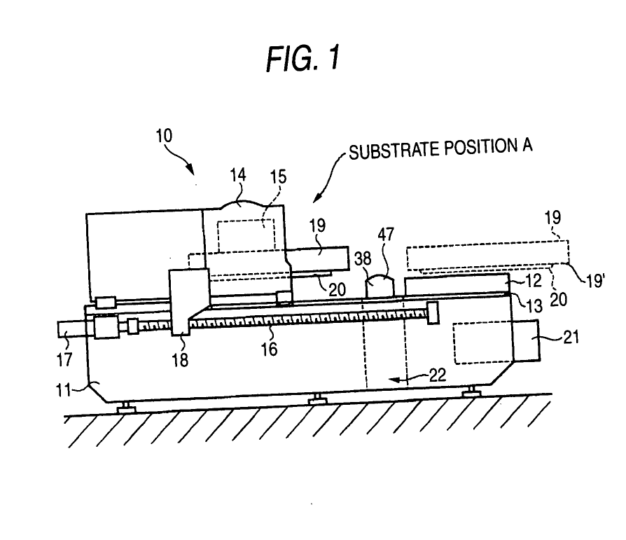

A method of forming a resist film according to the invention will be described by reference to FIGS. 1 to 7. More specifically, a description will be given of a method of forming a resist film on the coating surface (main surface) of a photomask blank substrate (hereinafter simply called the substrate) in the process of producing a large photomask according to this embodiment of the invention. Incidentally, the size of the substrate is 450 mm×550 mm.

FIG. 1 is a side view of a resist coater (CAP coater) for use in this embodiment of the invention.

A resist coating process will be described first.

A table 19 is placed at a substrate position A in FIG. 1. Then a substrate 20 is loaded to the facing-downward chucking surface 19′ of the table 19 with the coating surface of the substrate 20 facing downward.

The table 19 with the substrate 20 thus loaded thereto is moved by a motor 17 as well as a pair of laterally-movable frames 14 and 14 up to a position where coating is started as shown in FIG. 1. The lateral pair of moving frames 14 and 14 are linked integrally by a beam 15. The moving frames 14 and 14 are moved along linear ways 13 and 13 when a screw rod 16 provided on the left side of a base frame 11 is rotated by the motor l7. In other words, the left-side moving frame 14 is provided with a moving portion 18 having a female screw portion meshing with the screw rod 16. When the moving portion 18 moves forward as the screw rod 16 turns, the moving frames 14 and 14 are moved longitudinally.

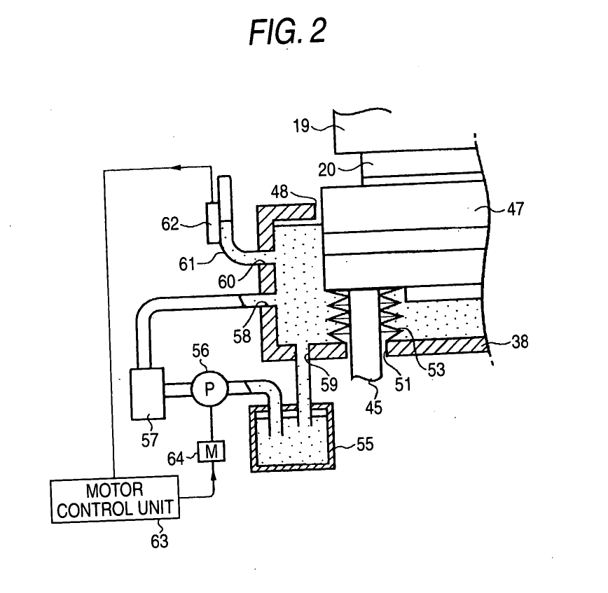

FIG. 2 is a schematic enlarged view of the periphery of a liquid tank 38 as well as a nozzle 47 for illustrating a resist circulation mode in the coater of FIG. 1.

As shown in FIG. 2, the liquid tank 38 is filled with resist liquid up to a predetermined height. In this case, the present height of the resist liquid is adjusted by a detection sensor 62 provided on the external side of a liquid-level regulating tube 61 and when the height of the resist liquid is rised up to the predetermined height, a motor control unit 63 causes a pump 56 to operate so as to supply the resist liquid. In other words, the resist is bailed out by the pump 56 from a tank 55 stored with the resist, so that the resist thus bailed out flows out from a supply port 58 opened in the side of the liquid tank 38 via a filter 57. Further, a circulatory port 59 is opened in the base of the liquid tank 38 and the resist is made to circulate from the circulatory port 59 into the tank 55. A through-hole 60 is formed in the upper portion of the side of the liquid tank 38 and the L-shaped liquid-level regulating tube 61 is projected from the through-hole 60. The upper end of the height regulating tube 61 is kept open. The detection sensor 62 for detecting the liquid height is provided on the external side of the height regulating tube 61. When the liquid tank 38 is filled with the resist, the liquid-level regulating tube 61 is also filled with the resist up to the same height as that in the liquid tank 38 and the then liquid level is detected by the detection sensor 62, the result of which is sent to the motor control unit 63 with a microcomputer. The motor control unit 63 causes the motor 64 of the pump 56 to be driven according to the result detected, so that the coating liquid is supplied to the liquid tank 38 up to the preset height.

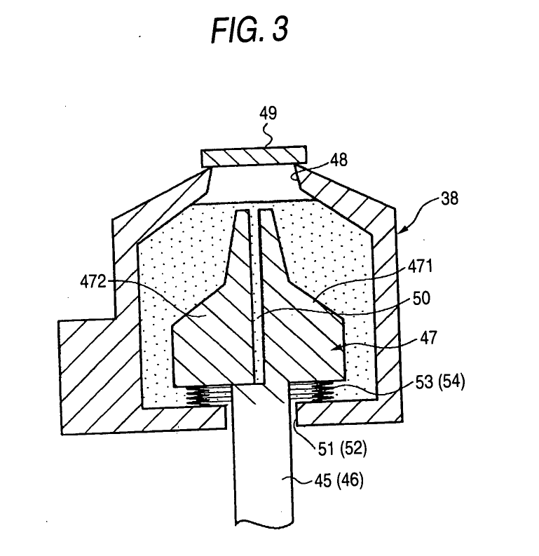

FIG. 3 is a schematic sectional view of the liquid tank 38 of the coater of FIG. 1.

As shown in FIG. 3, the nozzle 47 is kept in a submerged condition in the liquid tank 38 filled with the resist liquid. The liquid tank 38 longitudinally extended is substantially trapezoidal in cross section as shown in FIG. 3. A slit 48 longitudinally extended is formed in the upper end portion of the liquid tank 38. The slit 48 can be blocked by a cover 49 provided on the exterior of the liquid tank 38. The nozzle 47 is contained in the liquid tank 38 and formed with a pair of nozzle members including a front nozzle member 471 and a rear nozzle member 472 set opposite to each other with a laterally extending capillary gap 50 held therebetween. The front nozzle member 471 and the rear nozzle member 472 are longitudinally symmetrical in configuration and upwardly tapered in cross section like beaks.

Then the cover 86 of the slit 84 of the liquid tank 38 with the nozzle 47 submerged in the resist liquid is opened and the liquid tank 38 is lifted up to the lower side of the substrate 20 by means of a servo- motor (not shown).

Moreover, only the nozzle 47 is projected from the lifted liquid tank 38.

Rising of the nozzle is carried out by an air cylinder (not shown). When the nozzle 47 is lifted up from the resist liquid of the liquid tank 38, the nozzle 47 is lifted with the capillary gap 50 filled up with the resist liquid up to its front end since the capillary gap 50 has been filled with the resist liquid before being stopped to be lifted.

The liquid tank 38 is lifted again with the nozzle 47 projected as described above to bring the resist liquid into contact with the downside of the substrate 20, that is, to bring the resist liquid filled in the capillary gap 50 of the nozzle 47 into contact with the downside of the substrate 20.

Further, the liquid tank 38 together with the nozzle 47 is lowered to a coating height position with the liquid kept in contact with the downside of the substrate 20. Thus, a delicate adjustment can readily be made by using the servo- motor similarly as described above.

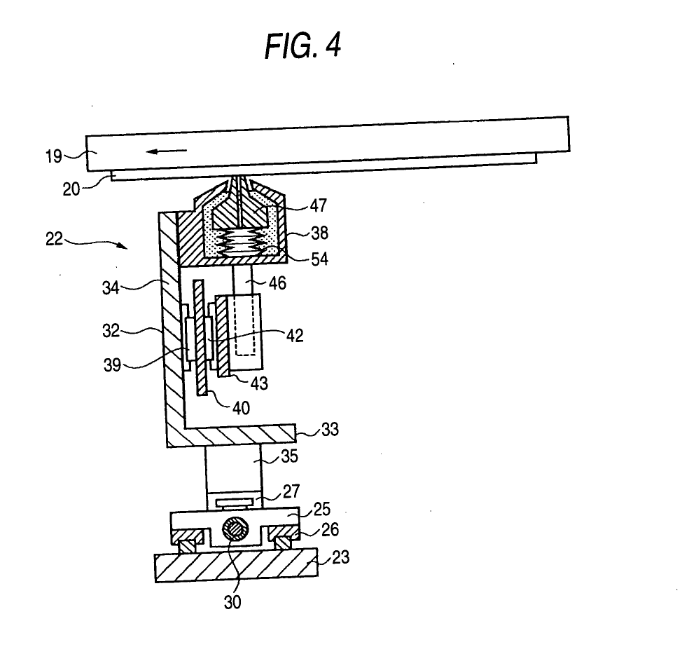

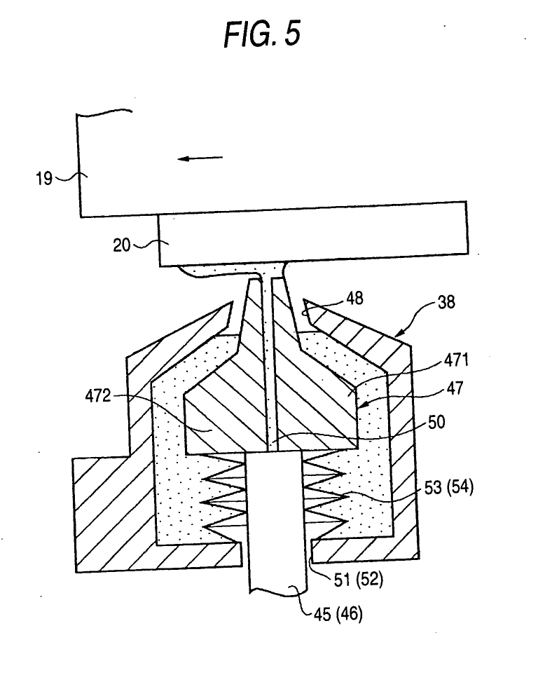

Coating of resist liquid will be described further by reference to FIGS. 4 and 5.

FIG. 4 is a side view of the coater of FIG. 1; and FIG. 5, a schematic sectional view illustrating the coating of the resist liquid in the liquid tank of the coater of FIG. 1.

After the nozzle 47 is lowered to the coating height position as described above, the substrate 20 is moved by the table 19 at the predetermined speed up to a position where the coating is terminated as shown by arrows in FIGS. 4 and 5. Then the resist liquid longitudinally discharged from the nozzle 47 can be applied levelly by moving the table 19 to the right as shown in FIG. 5 whereby to move the substrate 20 loaded to the table 19 by means of the motor 17. In other words, the resist liquid can be applied onto the substrate 20 levelly to required thickness. The postures in both longitudinal and lateral directions of the substrate 20 are leveled when the substrate 20 are carried. According to this embodiment of the invention, a liquid level, a coating gap, a substrate conveying speed and so on have been set to form a resist film having a thickness of 1 μm.

The coating process is terminated through the steps of stopping the substrate 20 once at the position where the coating is terminated, lowering the nozzle 47 and the liquid tank 38 from the respective coating heights and detaching the nozzle 47 and the liquid tank 38 from the substrate 20.

A drying process will be described next.

The motor 17 is used to move the substrate in the opposite direction by turning back the way the substrate has been moved for resist coating at the predetermined speed from the position where the coating is terminated while the substrate is held facing-downward by the table whereby to move the substrate up to the substrate position A. The substrate conveying speed at this time has been set to 7 m/min, whereupon the resist film is seen to have dried while the substrate is moving.

Then the suction force of the chucking surface 19′ is released so as to remove the substrate 20 from the table 19.

Thus, the substrate subjected to drying is seen to have been dried without being unevenly dried and the resist is formable without losing uniformity in film thickness.

As the substrate is loaded to vacuum chucking table with the coating surface of the substrate facing downward without using the rotary mechanism according to the invention, the vacuum chucking table is always kept leveled without jolting. It is therefore ensured that the substrate is prevented from stirring when it is coated with resist and this contribute to improving thin film quality.

For comparison, on the other hand, the substrate was dried at the position where the coating was terminated without conveying the substrate, which resulted in visually confirming unevenness in drying the resist film.

For comparison, further, the substrate was conveyed at a high speed of 2 m/min, as a result of which the substrate returned to the position where the coating is started without being dried, so that the substrate needed to be dried by setting the substrate immovable at the position where the coating was started. Then the resist film was dried while set immovable, which also resulted in confirming unevenness in drying the resist film.

Incidentally, the invention is not limited to the above embodiment thereof.

Although the resist film is dried during the time the substrate is moved in the opposite direction by turning back the way the substrate has been-moved according to the above embodiment of the invention, most of the resist film may be dried during the time the substrate is turned back the way before the substrate is stopped and subjected to finish drying.

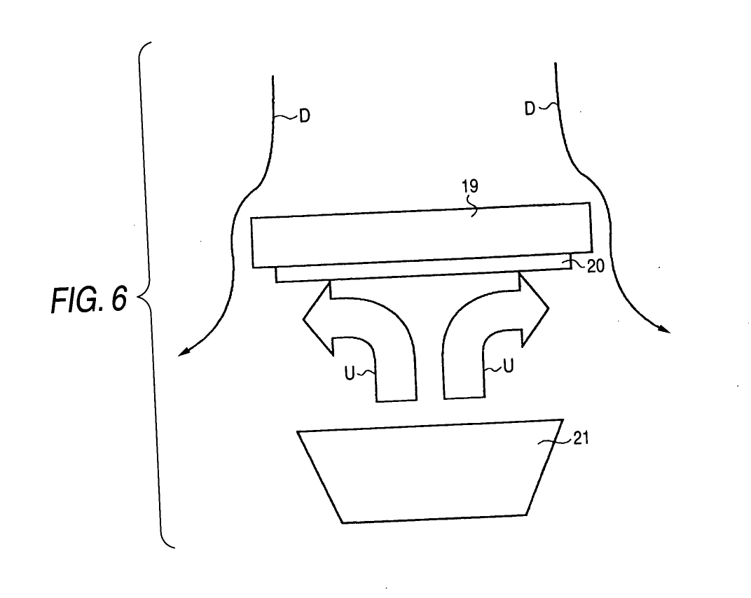

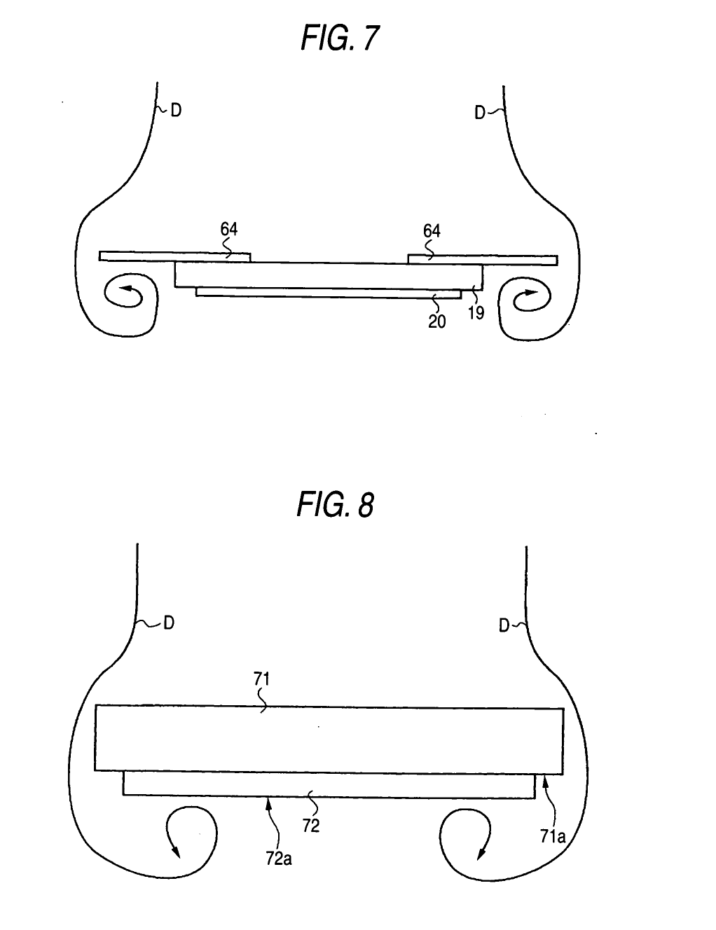

In this case, the resist film may typically be dried by causing an air current generator 21 to generate a clean air current U from below as shown in FIG. 6 or by providing a shield plate 64 in the peripheral edge portion of the coating surface of the substrate so as to shield a downflow whereby to restrain the downflow D from running around the coating surface as shown in FIG. 7.

Incidentally, FIG. 6 is a schematic depiction illustrating the installation of the air current generator below the substrate by way of example; and FIG. 7, a schematic depiction illustrating an example of mounting the shield plate to the chucking plate.

More specifically, the air current generator 21 above is equipped with fans for generating the air current directed upward and an air filter disposed above the fans. As the air filter, use can typically be made of a HEPA filter (High Efficiency Particulate Air filter).

While there has been described in connection with the preferred embodiments of the present invention, it will be obvious to those skilled in the art that various changes and modification may be made therein without departing from the present invention, and it is aimed, therefore, to cover in the appended claim all such changes and modifications as fall within the true spirit and scope of the present invention.

In the method of forming the resist film coated with the resist film by using the CAP coater according to the invention, unevenness in drying is reduced by drying the substrate while the substrate is moved at the predetermined speed with the coating surface of the substrate facing downward during the drying process, so that uniformity in the thickness of the resist film obtained can be improved.

What is claimed is:

1. A resist film forming method including a resist coating step, comprising steps of:
rising by a capillary phenomenon a coating liquid stored below the coating surface of a substrate held facing-downward;
bringing the rised coating liquid into contact with the coating surface via a nozzle; and
scanning the nozzle along the coating surface of the substrate thereby coating the resist film on the coating surface of the substrate,
wherein said method further including a step of drying the coated resist film by moving the substrate at a predetermined speed with the coating surface of the substrate facing downward.

2. A resist film forming method as set forth in claim 1, wherein the resist film is coated by moving the substrate so as to scan the nozzle along the coating surface of the substrate and the coated resist film is dried by moving the substrate to the opposite direction by turning back the way the substrate has been moved for resist coating.

3. A resist film forming method as set forth in claim 2, wherein the predetermined speed is 1.5 m/min or lower.

4. In a photomask manufacturing method, the improvement wherein the resist coating step comprising a step of
rising by a capillary phenomenon a coating liquid stored below the coating surface of a substrate held facing-downward;
bringing the rised coating liquid into contact with the coating surface via a nozzle; and
scanning the nozzle along the coating surface of the substrate thereby coating the resist film on the coating surface of the substrate,
wherein said method further including a step of drying the coated resist film by moving the substrate at a predetermined speed with the coating surface of the substrate facing downward.

5. A photomask manufacturing method as set forth in claim 4, wherein the resist film is coated by moving the substrate so as to scan the nozzle along the coating surface of the substrate and the coated resist film is dried by moving the substrate to the opposite direction by turning back the way the substrate has been moved for resist coating for drying the coated resist film.

6. A photomask manufacturing method as set forth in claim 5, wherein the predetermined speed is 1.5 m/min or lower.

7. A resist film forming method as set forth in claim 3, wherein the predetermined speed is ranging from 0.01 to 0.08 m/min.
